(19) United States
(12) Patent Application Publication
(10) Pub. No.: US 2015/0031384 A1
(43) Pub. Date: Jan. 29, 2015

(54) METHOD OF CANCELING CELL REFERENCE SIGNAL INTERFERENCES

(71) Applicant: Alcatel Lucent, Boulogne Billancourt (FR)

(72) Inventors: Qi Jiang, Shanghai (CN); Jianguo Liu, Shanghai (CN); Zheng Liu, Shanghai (CN)

(73) Assignee: Alcatel Lucent, Boulogne Billancourt (FR)

(21) Appl. No.: 14/373,162

(22) PCT Filed: Jan. 18, 2013
(86) PCT No.: PCT/IB2013/000513

§ 371 Date: Jul. 18, 2014

(30) Foreign Application Priority Data
Jan. 19, 2012 (CN) 201210017818.5

(51) Int. Cl. H04L 5/00

(52) U.S. Cl. CPC H04L 5/0032
USPC 455/452.1

(57) ABSTRACT

A method is provided in the invention to carry out cell reference signal interferences cancellations, the base station transmits configuration information of at least one cell to a UE (S30), the configuration information is used by the UE to cancel cell reference signal interference with respect to the cell, the at least one cell comprises one or more interference cells, the cell reference signals of which interfere with the UE actually. The UE receives the configuration information from the base station (S40), and carries out cell reference signal interferences cancellations with respect to the interference cell (S46). Further, the cell reference signal interferences cancellations can be triggered by the base station, or triggered by the UE (S42, S44). The method of carrying out cell reference signal interferences cancellations, provided by the invention, fills the blank of the prior art.

### TECHNICAL FIELD

The invention relates to wireless communications, especially relates to interference cancellations in wireless communications.

### BACKGROUND OF THE ARTS

Heterogeneous network (HetNet) has been added to the LTE-A work item, and, further enhanced inter-cell interference coordination (feICIC) for co-channel HetNet deployment becomes one of the key technical features of 3GPP LTE-A release 11. Co-channel comprises macro cells and micro cells operating on the same frequency channel. Such deployment mode generates some specific interference scenarios for which new inter-cell interference coordination (ICIC) technologies are required.

In one scenario, micro cells are picocells, which are open to UEs in macro cells. In order to ensure that such picocells carry a significant share of total traffic loads, UEs may be programmed to associate (access) preferably to the picocells rather than the macro cells. It can be achieved, for example, by biasing the SINR threshold, which is used for determining to associate (access) to a picocell, to a less value, thereby enabling UEs to select a picocell to associate with at a higher ratio. In this scenario, UEs near the edge of a picocell will suffer strong interferences from one or more macrocells. In order to alleviate the problem, some subframes may be configured as “almost blank subframe” (ABS for short) in a macro cell. An ABS generally contains no data transmission and little or no control signaling transmission. In release 10, X2 signaling can indicate an ABS pattern with a bitmap form (e.g. each bit in the bitmap indicates one of a series of subframes respectively, and the logic value of the bit indicates if the subframe is an ABS). A picocell can obtain the configuration information of an ABS in a macro cell via the signaling, and reasonably schedule the data transmission in a picocell, e.g. scheduling the data transmission of UEs at the edge of a picocell to the subframe at the same time with an ABS, and informing UEs to implement the measurement of RRM (radio resource management)/RLM (radio link management)/CSI (channel status indicator) on the subframes at the same time with the ABSs.

But, no matter whether a subframe is configured as an ABS or not, the eNB of the macro cell will transmit cell reference signals (CRS for short) on the subframes. It is for ensuring a backward compatibility with legacy UEs which expect to find the reference signals for measurements but are unaware of the existence of ABSs. ABSs also contain synchronization signals, broadcast control signals and/or paging signals etc. That means that the CRS of a macro cell always interfere with the data and control channels in a picocell on the same time. During 3GPP RAN1 discussion, the cell range expansion (CRE) by biasing cell selection is considered as one major method to extend the coverage of the picocell and to balance the traffic load. When the selected bias value for CRE becomes larger, the two above kinds of interferences will become more seriously.

A method of solving the interference has been provided in the industry, and it is called as cell reference signal interference cancellation (CRS Cancellation). In detail, the UEs in a picocell need to acquire the CRS sequence of the interference cell, the position corresponding to the time frequency resource transmitted, the port number of CRS (that's how many antennas are used to transmit CRS) and the subframes on which the CRSs are transmitted. By using the information, the picocell can cancel the interference of the CRS transmitted by the interference cell, from the received signals.

However, except the required necessary information mentioned above, the prior art doesn't discuss how to trigger and support CRS interference cancellation based on the existing standard.

### SUMMARY OF THE INVENTION

According to the aspect of the invention in a base station, a method is provided, in a base station, used for assisting UEs to carry out cell reference signal interferences cancellations, wherein, the method comprises the following steps:

transmitting configuration information of at least one cell to a UE, the configuration information is used by the UE to cancel cell reference signal interference with respect to the cell,

wherein, the at least one cell comprises one or more interference cells, the cell reference signals of which interfere with the UE actually.

According to an embodiment, the cell reference signal interferences cancellations is triggered by the base station, and the method still comprises the following steps before the transmitting steps:

determining the interference cell which generates cell reference signal interferences for the UE;

in the transmitting step, transmitting the configuration information of only the interference cell to the UE.

In the embodiment, the interference cell is selected by a base station, which reduces the operation complexity of UEs; and the base station transmits the configuration information of only the interference cell to the corresponding UE, which saves the network bandwidth.

According to a further preferred embodiment, the transmitting step transmits in a part of the UEs-dedicated way,

wherein, the configuration information is transmitted in a PhysicalConfigDedicated information element.

In the embodiment, the configuration information of corresponding interference cell is transmitted to specific UEs, to avoid using a broadcasting mode, which has a stronger pertinence and save broadcast resources.

According to a further preferred embodiment, the determining step comprises at least any one of the following:

determining the position of the UE according to a location service, and determining the interference cell according to the position and the topology structure of the deployed wireless network;

determining the interference cell, according to detected and reported interference related information, transmitted by the UE, of each neighbor cell or a par of neighbor cells, wherein, the interference related information comprises any one of the following:

reference signal receive power;

reference signal receive quality;

channel status indicator.

In the embodiment, it provides two detailed implementing methods of determining an interference cell in a base station, which can accurately determine the interference cell interfering with UEs, thus allows UEs carry out accurate CRS interference cancellations to improve communication performance.

According to another embodiment, the cell reference signal interferences cancellation is triggered by the UE, and

in the transmitting step, the configuration information of all potential interference cells of the UE is transmitted to the UE.

In the embodiment, the interference cell is selected by UEs, which saves the working load of a base station.

According to a further preferred embodiment, transmitting the configuration information of all neighbor cells of the cell administrated by the base station to all UEs in the administrated cell via broadcast,

wherein, the configuration information is transmitted in a SystemInformationBlockType4 information element.

In the embodiment, all neighbor cells are taken as potential interference cells, and their configuration information are transmitted to all UEs via broadcast without being transmitted later, thereby reducing the working load of a base station and saving the unicast resources.

According to another embodiment, the base station and the at least one cell belong to a heterogeneous network, the base station is a pico-base station, the at least one cell is a macro cell, and

the configuration information comprises the following:

an identification of the interference cell;

number of ports of the cell reference signal of the interference cell;

sub-frame configuration;

format information of the almost blank sub-frame.

The embodiment provides detailed applications of the invention in heterogeneous network, which can solve the triggering problem of CRS interference cancellations currently existed in heterogeneous networks.

According to the aspect of the invention in UEs, a method is provided, in a UE, for carrying out cell reference signal interferences cancellations, wherein, the method comprises the following steps:

receiving configuration information of at least one cell from a base station, wherein, the at least one cell comprises one or more interference cells, the cell reference signals of which interfere with the UE actually.

carrying out the cell reference signal interferences cancellations with respect to the interference cell according to the configuration information.

### BRIEF DESCRIPTION OF THE DRAWINGS

By reading the detailed description of the non-limiting embodiment referring to the following drawings, other features, objects and advantages of the invention will become clearer:

FIG. 1 is the method flow chart of CRS interference cancellations triggered by a base station, according to an embodiment of the invention;

FIG. 2 is the method flow chart of CRS interference cancellations triggered by UEs, according to another embodiment of the invention.

### DETAILED EMBODIMENT

According to the basic idea of the invention, a method is provided, used for carrying out cell reference signal interferences cancellations, wherein:

the base station transmits configuration information of at least one cell to a UE, the configuration information is used by the UE to cancel cell reference signal interference with respect to the cell, the at least one cell comprises one or more interference cells, the cell reference signals of which interfere with the UE actually.

the UE receives configuration information of at least one cell from a base station, and according to the configuration information, carries out cell reference signal interferences cancellations with respect to the interference cell.

The following lists respectively two detailed embodiments based on the invention idea, wherein, the cell reference signal interferences cancellations (CRS interference cancellations) is triggered respectively by the base station and UEs.

### A First Embodiment

In the embodiment, CRS interference cancellations are triggered by a base station, namely the eNB decides when and how to carry out the CRS interferences cancellations with respect to the interference cells, and transmits configuration information of the interference cells to UEs, as the suggestion of CRS interference cancellations to indicate UEs to carry out the CRS interferences cancellations.

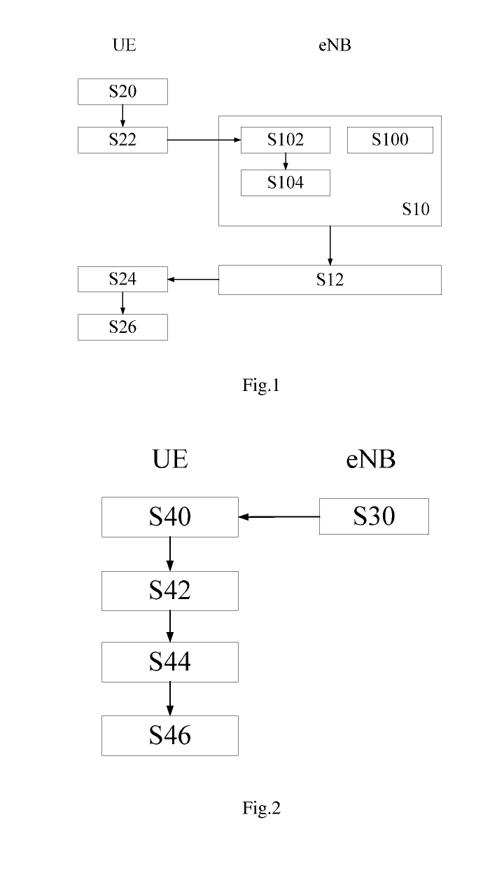

In detail, shown as FIG. 1, in the step S10, the eNB determines interference cells which generate CRS interference to the UE.

In detail, in an embodiment, in the step S100, the eNB can obtain the UE position by the location service of an upper layer, e.g. three base station location, and determines the interference cell by combining with the topology deployed of wireless network. E.g., the eNB is a pico-base station in HetNet, it acquires the UE position, and acquires that the UE is currently in the edge of the picocell and near a macro cell M, then the eNB can determine that the macro cell M is an interference cell.

In another embodiment, in the step S20, a UE can detect interference related information of each neighbor cell, according to the indication of an eNB, wherein, the interference related information comprises any one of the following:

reference signal receive power (RSRP);

reference signal receive quality (RSRQ);

channel status indicator (CSI).

Wherein, the eNB can instruct all UEs to carry out the above measurements, to determine whether each UE receives interferences respectively. The UE can detect PCID and CRS sequence of neighbor cells, and acquire the position of time-frequency resource (subcarrier, OFDM symbols etc.) of the transmitted CRS in neighbor cell, thus the UE measures the above RSRP/RSRQ/CQI according to these information.

Then, in the step S22, the UE transmits the detected interference related information of each neighbor cell to the eNB. Alternatively, the UE may carry out preliminary screening, and transmit to the eNB the interference related information meeting certain conditions, e.g. the part of neighbor cells whose RSRP/RSRQ is greater than a threshold.

In the step S102, the eNB receives the interference related information of neighbor cells transmitted by the UE. In the step S104, the eNB determines the interference cell, e.g. taking the interference related information meeting certain conditions as the interference cell, e.g. the part of neighbor cells which RSRP/RSRQ is greater than a threshold.

Then, in the step S12, the eNB transmits the configuration information of only the interference macro cell M to the UE. The eNB can obtain the configuration information of the macro cell M through OAM (operation, administration and maintenance) in the network deployment phase.

It may be understood that the interference cell is specific to the UE, not common to all UEs administered by the eNB. Thus, not all the UEs need to receive the configuration information. Thus, preferably, the eNB places the configuration information in RRC signaling to transmit it to the UE in a UE-dedicated way.

The embodiment improves the PhysicalConfigDedicated information element in RRC signaling in which the configuration information fields of the interference cell is added. The data structure of the PhysicalConfigDedicated information element is shown as the following:

-- ASN1START
PhysicalConfigDedicated ::= SEQUENCE {

| | | | |
|---|---|---|---|
| pdsch-ConfigDedicated | PDSCH-ConfigDedicated | OPTIONAL, | -- Need ON |

| | | | |
|---|---|---|---|
| pucch-ConfigDedicated | PUCCH-ConfigDedicated | OPTIONAL, | -- Need ON |

| | | | |
|---|---|---|---|
| pusch-ConfigDedicated | PUSCH-ConfigDedicted | OPTIONAL, | -- Need ON |

| | | | |
|---|---|---|---|
| uplinkPowerControlDedicated | UplinkPowerControlDedicated | OPTIONAL, | -- Need ON |
| tpc-PDCCH-ConfigPUCCH | TPC-PDCCH-Config | OPTIONAL, | -- Need ON |
| tpc-PDCCH-ConfigPUSCH | TPC-PDCCH-Config | OPTIONAL, | -- Need ON |

| cqi-ReportConfig | COI-ReportConfig | OPTIONAL, | -- Need ON |
|---|---|---|---|
| soundingRS-UL-ConfigDedicated | SoundingRS-UL-ConfigDedicated | OPTIONAL, | -- Need ON |
| antennaInfo | CHOICE { | | |
| explicitValue | AntennaInfoDedicated, | | |
| defaultValue | NULL | | |
| } OPTIONAL, | | | -- Need ON |
| schedulingRequestConfig | SchedulingRequestConfig OPTIONAL, | | -- Need ON |
| ..., | | | |
| [[ cqi-ReportConfig-v920 | CQI-ReportConfig-v920 | OPTIONAL, | -- Need ON |
| antennaInfo-v920 | AntennaInfoDedicated-v920 | OPTIONAL | -- Need ON |
| ]] | | | |

| | |
|---|---|
| InterferingCellList ::= | SEQUENCE (SIZE (1..maxInterferingCell)) OF InterferingCell |

OPTIONAL,
InterferingCell ::= SEQUENCE {

| | |
|---|---|
| physCellId | PhysCellId, |
| CRS-Ports | ENUMERATED { 1, 2, 4 } |
| SF-Config | BIT STRING (SIZE(2)), |
| abs-pattern-info | BIT STRING (SIZE(40)), |
| OPTIONAL, | |

| | |
|---|---|
| } | OPTIONAL, |
| } | |
| } | |
| -- ASN1STOP | |

Wherein, the bold fields are extension fields of the

PhysicalConfigDedicated information element with respect to the embodiment, and the description of the fields is the following:

PhysicalConfigDedicated
Fields description

InterferingCellList
Representing the list of interference cells, the list includes one or multiple
InterferingCell fields
InterferingCell
Representing an interference cell, including the configuration information
of the interference cell
physCellId
PCID (PhysCellId, that's physical cell ID) of the interference cell
CRS-Ports
The number of ports used by the interference cell to transmit CRS
The value 1 means CRS uses a single antenna port to transmit,
The value 2 means CRS uses two antenna ports to transmit, etc.
SF-Config
Subframe configuration
The bitmap value is “00” meaning zero power ABS,
The bitmap value is “01” meaning taking MBSFN subframe as ABS,
Other reserved.
ABS-Pattern-Info
ABS pattern information described with bitmap, each bit in the bitmap
corresponds to one of a series of subframes respectively, and the logic
value of the bit indicates whether the subframe is an ABS.
The value 1 means almost blank downlink subframe,
The value 0 means non-almost blank downlink subframe.

The meanings of other fields are the same as that specified in the current standard, and the specification will not give unnecessary discussion.

The UE receives the configuration information of the interference macro cell M in the step S24.

When the UE needs to receive the data transmitted by the pico-base station or carry out channel measurements in the ABS subframe, in the step S26, it carries out the cancellations of CRS transmitted by the interference macro cell M, based on the configuration information, CRS sequence and resources CRS sequence locating. The technology of the UE for carrying out the CRS interferences cancellations is well known in the art, and the invention will not give unnecessary discussion.

In the above embodiment, the interference cell is only the macro cell M, while in other embodiments, the eNB may determine multiple interference cells. In such case, the eNB may transmit the configuration information of the multiple interference cells to the UE, thus the UE can carry out accurate CRS interferences cancellations.

In the above embodiments, the CRS interferences cancellations are triggered by the eNB. The following will describe in detail a second embodiment of the invention, wherein, the CRS interferences cancellations are triggered by the UE.

### The Second Embodiment

In the embodiment, the CRS interferences cancellations are triggered by the UE, that's, the UE determines when and how to carry out the CRS interferences cancellations with respect to the interference cell. The eNB is not responsible for differentiating which neighbor cell is to interfere with the UE, and allows the UE to select the interference cell by the UE itself. And the eNB can inform the UE of the configuration information of all potential interference cells that probably generate interferences, to enable the UE to retrieve the configuration information of the interference cell and carry out the CRS interferences cancellations, after selecting the interference cell by itself.

In detail, shown as FIG. 2, in the step S30, the eNB transmits the UE the configuration information of all potential interference cells of the UE.

More preferably, since all neighbor cells of the cell administrated by the eNB may become the interference cells of the UE, thus, the eNB transmits to UEs in the administrated cell the configuration information of all neighbor cells of the cell administrated by the eNB via broadcast, to ensure UEs can carry out the CRS interferences cancellations. The eNB can obtain the configuration information of all neighbor cells through OAM (operation, administration and maintenance) in the network deployment phase.

Based on current standard, the embodiment of the invention places the configuration information in SystemInformationBlockType4 (short for SIB4) information element. The SIB4 information element is broadcasted to all UEs in data channels. To contain the configuration information, the data structure of SIB4 information element is extended, and the extended information element is shown as the following.

| -- ASN1START | | | |
|---|---|---|---|
| SystemInformationBlockType4 ::= | SEQUENCE { | | |
| intraFreqNeighCellList | IntraFreqNeighCellList | OPTIONAL, -- Need OR | |
| intraFreqBlackCellList | IntraFreqBlackCellList | OPTIONAL, -- Need OR | |
| csg-PhysCellIdRange | PhysCellIdRange | OPTIONAL, | -- Cond CSG |
| ..., | | | |
| lateNonCriticalExtension | OCTET STRING | OPTIONAL | -- Need OP |
| } | | | |

| | |
|---|---|
| IntraFreqNeighCellList ::= | SEQUENCE (SIZE (1..maxCellIntra)) OF IntraFreqNeighCellInfo |
| IntraFreqNeighCellInfo ::= | SEQUENCE { |

| physCellId | PhysCellId, | |
|---|---|---|
| q-OffsetCell | Q-OffsetRange, | |
| CRS-Ports | ENUMERATED { 1, 2, 4 } | |
| OPTIONAL, | | |
| SF-Config | BIT STRING (SIZE(2)), | OPTIONAL, |
| abs-pattern-info | BIT STRING (SIZE(40)), | |
| OPTIONAL, | | |
| ... | | |
| } | | |

| | |
|---|---|
| IntraFreqBlockCellList ::= | SEQUENCE (SIZE (1..maxCellBlock)) OF PhysCellIdRange |
| -- ASN1STOP | |

Wherein, IntraFreqNeighCellList field means the neighbor cell list with the same frequency, which includes one or multiple IntraFreqNeighCellInfo fields, each IntraFreqNeighCellInfo field respectively describes a neighbor cell. The bold field in IntraFreqNeighCellInfo field is the extension of SIB4 information element by the embodiment, and the description of the fields is as the following:

SystemInformationBlockType4
Fields description

CRS-Ports
Representing the number of ports used by the interference cell transmitting
CRS
The value 1 means CRS uses a single antenna port to transmit,
The value 2 means CRS uses two antenna ports to transmit, etc.
SF-Config
Representing subframe configuration
The bitmap value is “00” meaning zero power ABS,
The bitmap value is “01” meaning taking MBSFN subframe as ABS,
Other reserved.
ABS-Pattern-Info
ABS pattern information described with bitmap, each bit in the bitmap
corresponds to one of a series of subframes respectively, and the logic
value of the bit indicates if the subframe is an ABS.
The value 1 means almost blank downlink subframe,
The value 0 means non-almost blank downlink subframe.

The meanings of other fields are the same as the current standard specified, and the specification will not give unnecessary discussion.

Correspondingly, in the step S40, the UE receives from the eNB the configuration information of all neighbor cells of the cell administrated by the eNB via broadcast, wherein, the configuration information of the neighbor macro cell M is included.

Then, in the step S42, the UE should be able to accurately estimate PCID and CRS sequences of neighbor cells, and detect interference related information of each neighbor cell. In detail, the interference related information comprises any one of the following:

reference signal receive power (RSRP);

reference signal receive quality (RSRQ);

channel status indicator (CSI).

Certainly, the interference related information may still be other measurement results obtained by the UE. The UE can detect PCID and CRS sequence of neighbor cells, and acquire the resource (subcarrier, OFDM symbols etc.) of the transmitted CRS of the neighbor cell, thus the UE measures the above RSRP/RSRQ/CQI according to these information.

Then, in the step S44, the UE determines the interference cell according to each interference related information. E.g., the UE may determine the neighbor cell, with a RSRP/RSRQ greater than a certain threshold, as the interference cell. In the embodiment, the RSRP/RSRQ of the macro cell M is greater than the threshold, then the UE determines the macro cell M as the interference cell.

Then, the UE selects the configuration information of the interference macro cell M form the configuration information of all neighbor cells.

When the UE receives the data transmitted by a pico-base station or carries out channel measurement in the ABS subframe, in the step S46, based on the above configuration information, CRS sequence, CRS transmitting resource, the UE carries out cancellations of CRS transmitted by the interference macro cell M. The technology of the UE for carrying out the CRS interferences cancellations is well know in the art, and the specification will not give unnecessary discussion.

In the above embodiment, the interference cell is only the macro cell M, while in other embodiments, the UE may determine multiple interference cells. In such condition, since the eNB has transmitted the configuration information of all neighbor cells comprising the multiple interference cells to the UE, the UE selects the configuration information of all interference cells from the all neighbor cells, and carries out accurate CRS interferences cancellations.

It needs to specify that, in the case of non-conflict, the embodiments of the application and the features in the embodiments may be combined with each other in any manner.

Certainly, there are other many embodiments for the invention, without departing from the spirit and essence, those skilled in the art may make various kinds of corresponding changes and modifications according to the invention, while the corresponding changes and modifications should belong to the protect scope of the appended claims.

The ordinary skilled in the art may understand that all or partial steps in the above methods can be achieved through programs instructing related hardware, the programs may be stored in computer-readable storage mediums, e.g. a read-only memory, disk or CD-ROM etc. Optionally, all or partial steps in the above embodiments may be achieved by using one or multiple integrated circuits. Correspondingly, each module/unit in the above embodiments may take the form of either hardware or software functional module to achieve. The invention isn't limited to any specific forms of combination of hardware and software.

1. A method, in a base station, used for assisting UEs to carry out cell reference signal interferences cancellation, wherein, the method comprises:
transmitting configuration information of at least one cell to a UE, the configuration information is used by the UE to cancel cell reference signal interference with respect to the cell,
wherein, the at least one cell comprises one or more interference cells, the cell reference signals of which interfere with the UE actually.

2. A method of claim 1, wherein, the cell reference signal interferences cancellation is triggered by the base station, and the method still comprises the following before the transmitting:
determining the interference cell which generates the cell reference signal interferences for the UE;
the transmitting transmits the configuration information of only the interference cell to the UE.

3. A method of claim 2, wherein, the transmitting transmits in a part of UEs-dedicated way,
wherein, the configuration information is transmitted in a PhysicalConfigDedicated information element.

4. A method of claim 2, wherein, the determining comprises at least any one of the following:
determining the position of the UE according to a location service, and determining the interference cell according to the position and the topology structure of the deployed wireless network;
determining the interference cell, according to detected and reported interference related information, transmitted by the UE, of each neighbor cell or a part of neighbor cells, wherein, the interference related information comprises any one of the following:
reference signal receive power;
reference signal receive quality;
channel status indicator.

5. A method of claim 1, wherein, the cell reference signal interferences cancellation is triggered by the UE, and
the transmitting transmits to the UE the configuration information of all potential interference cells of the UE.

6. A method of claim 5, wherein, the transmitting transmits the configuration information of all neighbor cells of the cell administrated by the base station to all UEs in the administrated cell via broadcast,
wherein, the configuration information is transmitted in a SystemInformationBlockType4 information element.

7. A method of claim 1, wherein, the base station and the at least one cell belong to a heterogeneous network, the base station is a pico-base station, the at least one cell is a macro cell, and
the configuration information comprises the following:
an identification of the interference cell;
the number of ports of the cell reference signal of the interference cell;
a sub-frame configuration;
format information of the almost blank sub-frame.

8. A method, in a UE, for carrying out cell reference signal interferences cancellations, wherein, the method comprises:
receiving configuration information of at least one cell from a base station, wherein, the at least one cell comprises one or more interference cells, the cell reference signals of which interfere with the UE actually.
carrying out the cell reference signal interferences cancellations with respect to the interference cell according to the configuration information.

9. A method of claim 8, wherein, the cell reference signal interferences cancellations is triggered by the base station, and
the receiving receives the configuration information of only the actual interference cells which the base station transmits.

10. A method of claim 9, wherein, the receiving receives in a user-specific way,
wherein, receiving the configuration information in a PhysicalConfigDedicated information element.

11. A method of claim 9, wherein, the method comprises the following before the receiving:
detecting interference related information of each neighbor cell; and
transmitting the interference related information of each neighbor cell or a part of neighbor cells to the base station;
wherein, the interference related information comprises any one of the following:
reference signal receive power;
reference signal receive quality;
channel status indicator.

12. A method of claim 8, wherein, the cell reference signal interferences cancellations is triggered by the UE,
the receiving receives the configuration information of all potential interference cells of the UE;
the method comprises the following before carrying out the cell reference signal interferences cancellations:
determining the actual interference cell;
the carrying out the cell reference signal interferences cancellations selects the configuration information of actual interference cell from the configuration information of all potential interference cells, and carrying out the cell reference signal interferences cancellations according to the configuration information.

13. A method of claim 12, wherein, the receiving receives the configuration information, sent via broadcast, of all neighbor cells of the cell administrated by the base station,
wherein, receiving the configuration information in a SystemInformationBlockType4 information element.

14. A method of claim 12, wherein, the determining comprises:
detecting interference related information of each neighbor cell; and
determining the interference cell according to each interference related information;
wherein, the interference related information comprises any one of the following:
reference signal receive power;
reference signal receive quality;
channel status indicator.

15. A method of claim 8, wherein, the base station and at least one cell belong to a heterogeneous network, the base station is a pico-base station, the at least one cell is a macro cell, and
the configuration information comprises the following:
an identification of the interference cell;
the number of ports of the cell reference signal of the interference cell;
a sub-frame configuration;
format information of the almost blank sub-frame.
